(19) United States
(12) Patent Application Publication
(10) Pub. No.: US 2018/0211344 A1
(43) Pub. Date: Jul. 26, 2018

(54) AUTOMATED ENTERPRISE-CENTRIC CAREER NAVIGATION

(71) Applicant: International Business Machines Corporation, Armonk, NY (US)

(72) Inventors: Deirdre J. Angus, Melbourne (AU); Alison E. Dalby, Spokane, WA (US); Kelli L. Jordan, Raleigh, NC (US); Anthony E. Martinez, Orcas, WA (US); Ronald J. Salpietra, Huntersville, NC (US)

(21) Appl. No.: 15/719,758

(22) Filed: Sep. 29, 2017

Related U.S. Application Data
(63) Continuation of application No. 15/412,079, filed on Jan. 23, 2017.

(51) Int. Cl. G06Q 50/20; G06Q 10/10

(52) U.S. Cl. CPC G06Q 50/2057; G06Q 10/105

(57) ABSTRACT

A method, executed by a computer, includes determining, via machine learning, skills associated with various positions in an organization, receiving a profile for a user including a current position for the user, and receiving a target position for the user. The method further includes determining from the profile for the user and the skills associated with various positions in an organization, one or more acquirable skills that would enable the user to achieve the target position from the current position, determining one or more professional development activities that correspond to the acquirable skills, and presenting the acquirable skills and the professional development activities to the user. A computer system and computer product corresponding to the above method are also disclosed herein.

### BACKGROUND

The present invention relates generally to the field of career guidance, and more particularly to automated career guidance.

Employee satisfaction within an organization is highly dependent on the opportunities for growth and upward mobility. However, meaningful career guidance is typically too labor intensive and costly for most enterprises to undertake. Furthermore, career opportunities and career training requirements are constantly changing. Particularly in large corporations, employees can easily become isolated and unaware of upcoming internal opportunities and how they might qualify for those opportunities.

### SUMMARY

A method, executed by a computer, includes determining, via machine learning, skills associated with various positions in an organization, receiving a profile for a user including a current position for the user, and receiving a target position for the user. The method further includes determining from the profile for the user and the skills associated with various positions in an organization, one or more acquirable skills that would enable the user to achieve the target position from the current position, determining one or more professional development activities that correspond to the acquirable skills, and presenting the acquirable skills and the professional development activities to the user. A computer system and computer product corresponding to the above method are also disclosed herein.

### BRIEF DESCRIPTION OF THE DRAWINGS

FIG. 1 is a data flow diagram depicting one example of a positional skill analysis method in accordance with at least one embodiment disclosed herein;

FIG. 2 is a flowchart depicting one example of an automated career navigation method in accordance with at least one embodiment disclosed herein;

FIGS. 3A, 3B, and 3C are screen shots depicting several examples of user interfaces in accordance with at least one embodiment of the present invention;

FIG. 4 is a dependency graph depicting one example of a career navigation map in accordance with at least one embodiment of the present invention;

FIG. 5 is a block diagram depicting one example of a computing apparatus (e.g., cloud computing node) suitable for executing the methods disclosed herein;

FIG. 6 depicts a cloud computing environment in accordance with to at least one embodiment of the present invention; and

FIG. 7 depicts abstraction model layers in accordance with at least one embodiment of the present invention.

### DETAILED DESCRIPTION

The embodiments disclosed herein recognize that for employees, navigating career growth or career development—especially at large organizations—can be challenging. Employees often get confused and discouraged about next steps and may choose to look for new opportunities elsewhere. Employers aren't able to provide the level of support employees seek, and as a result, encounter employee engagement issues and voluntary or regretted attrition.

The embodiments disclosed herein also recognize that employees find it difficult to advance their career for at least the following:
Beneficial career growth opportunities/skill development activities are unknown to the employee or are not readily and easily identifiable.
Too many career growth opportunities/skill development activities exist and it is unclear to the employee on which ones will advance or accelerate their career development in the long term.
It is unclear to the employee on how certain opportunities/skill development activities will advance their career.
It is unclear to the employee what additional skills or capabilities they need to fulfill an opportunity and if they are currently fully qualified to fulfill an opportunity.
It is unclear to the employee as to what is the best, most optimized way to advance their career.

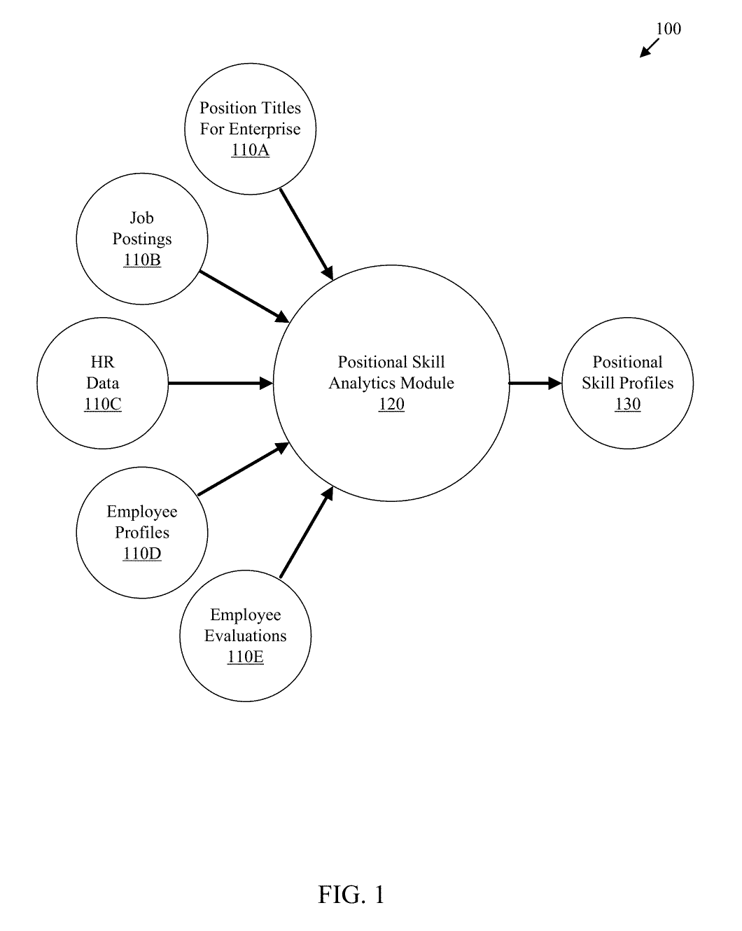

FIG. 1 is a data flow diagram depicting one example of positional skill analysis method 100 in accordance with at least one embodiment disclosed herein. As depicted, the method 100 receives a number of data inputs 110, executes a positional skill analytics module 120, and produces one or more positional skill profiles 130. The produced positional skill profiles 130 that can be used to provide automated career navigation to employees of an organization or enterprise.

The data inputs 110 may be sources of data that are relevant to creating skill profiles (i.e., the positional skill profiles 130) for various positions in an enterprise. The depicted data inputs 110 include positional titles 110A, job postings 110B, human resources (HR) data 110C, employee profiles 110D, and employee evaluations 110E. The positional titles 110A may be used to determine which positions in an enterprise should be evaluated for needed or beneficial skills. Specific examples of positional titles [used herein to illustrate various embodiments] include “software tester”, “programmer”, “developer”, “software architect”, and “senior software architect”.

The job postings 110B may describe various aspects of specific positions including desired education and experience, required certifications, compensation, and the like. The job postings may be specific postings for the enterprise. However, the job postings may be obtained from internal or external sources (e.g., a job postings website).

The human resources (HR) data 110C may be internally defined descriptions of specific jobs including desired and required education, skills, and certifications. The human resources (HR) data 110C may also describe compensation ranges for specific jobs and their associated benefits. The employee profiles 110D may describe the current and former positions specific employees have held, as well as their education, skills, certifications, and compensation. The employee evaluations 110E may rate specific employees on their job performance including technical abilities, leadership, and ability to work with others.

The positional skill analytics module 120 may leverage the various sources of data 110 and find correlations between skills and effective job performance. Those correlations may be used to generate the positional skill profiles 130. In some embodiments, the positional skill analytics module 120 leverages statistical correlation tools or services such as SPSS® and other tools and services available from IBM®.

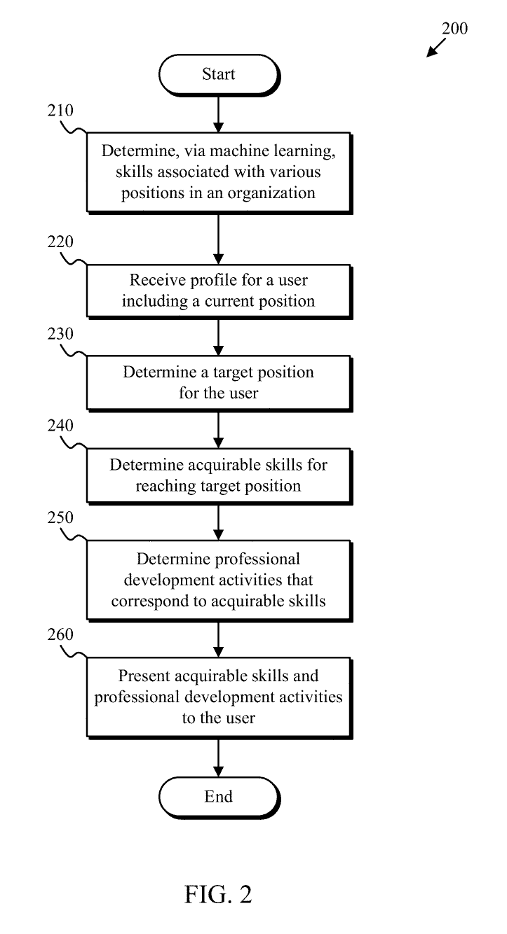

FIG. 2 is a flowchart depicting one example of an automated career navigation method 200 in accordance with at least one embodiment disclosed herein. As depicted, the automated career navigation method 200 includes determining (210) skills associated with positions in an organization, receiving (220) a user profile, determining (230) a target position for the user, determining (240) acquirable skills, determining (250) professional development activities, and presenting (260) the acquirable skills and professional development activities to the user. The automated career navigation method 200 leverages the positional skill profiles 130 or similar data, to provide automated career navigation to employees.

Determining (210) skills associated with positions in an organization may include conducting the positional skill analysis method 100 to produce one or more positional skill profiles 130.

Receiving (220) a user profile may include receiving a profile that indicates the current and former positions for the user within the enterprise as well as education, skills, and certifications achieved by the user. The profile may also indicate the performance of the user in current and former positions.

Determining (230) a target position for the user may include enabling a user to select a target position. For example, user interface controls may be provided to a user that enables the user to select specific criteria for a target position. The user interface controls may enable the user to select a specific target position from a list of possible target positions that conform to the selected criteria.

Determining (240) acquirable skills may include comparing the current skills of the user with the positional skill profile for the target position and determining the skills that the user could acquire to qualify for, and/or excel at, the target position.

Determining (250) professional development activities may include determining developmental activities that the user could engage in to develop the acquirable skills.

Presenting (260) the acquirable skills and professional development activities to the user may include presenting information to the user on the acquirable skills and professional development activities. In one embodiment, a map is presented that shows a pathway from the current position to the target position.

To provide relevant guidance, the above method may account for current or future organizational priorities. For example, the list of possible target positions and/or their order of presentation may reflect current or anticipated demand for those positions. Furthermore, the acquirable skills and professional development activities may reflect the current or anticipated needs of the organization as a whole and/or specific target positions. In some embodiments, an administrator, or the like, specifies the current or anticipated demand or value to the organization. In certain embodiments, the data sources 110 are used to automatically or semi-automatically determine the current or anticipated demand for specific positions.

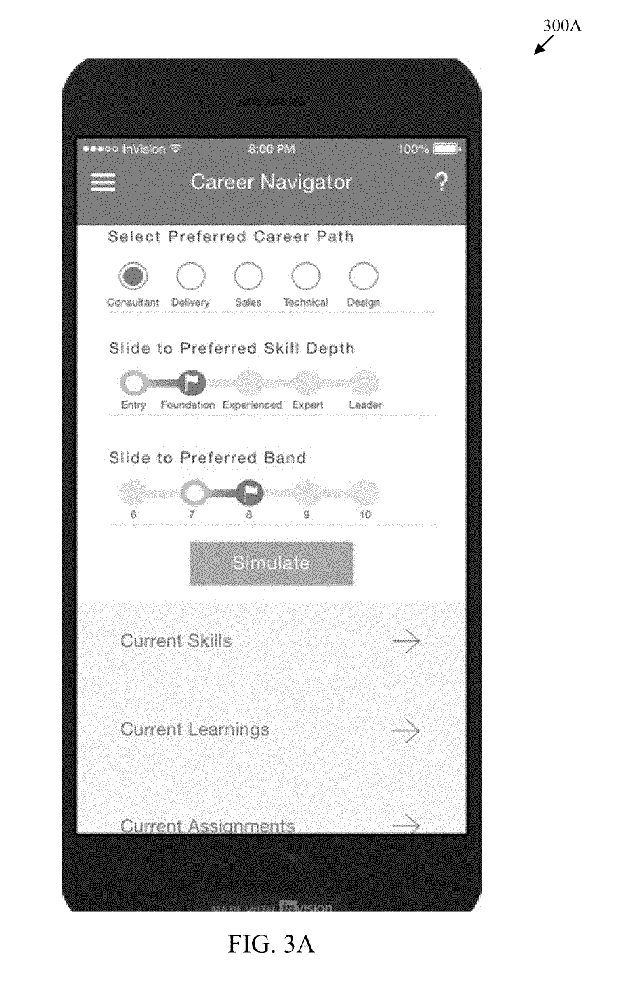

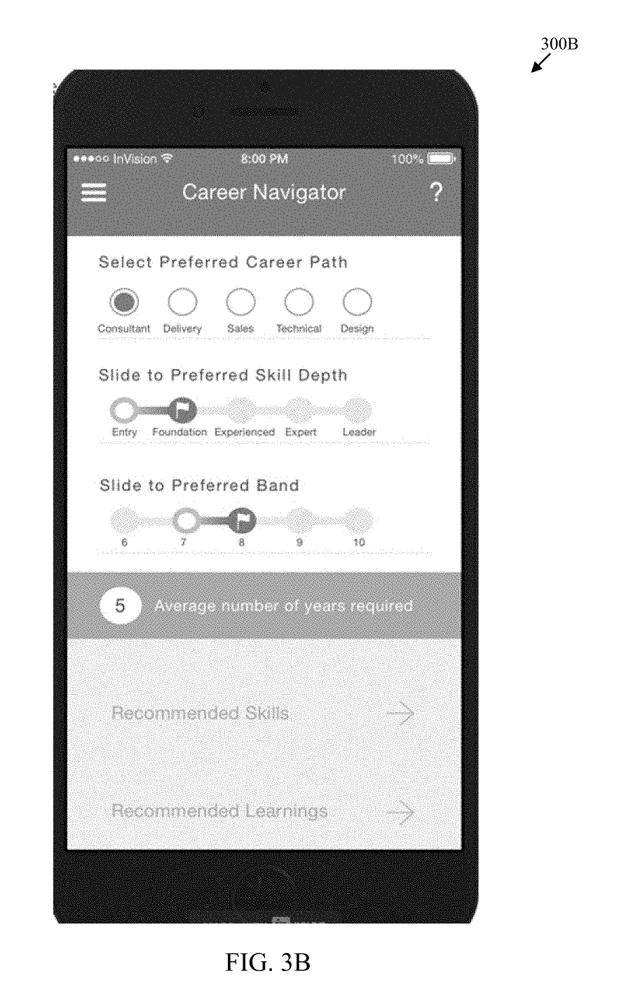

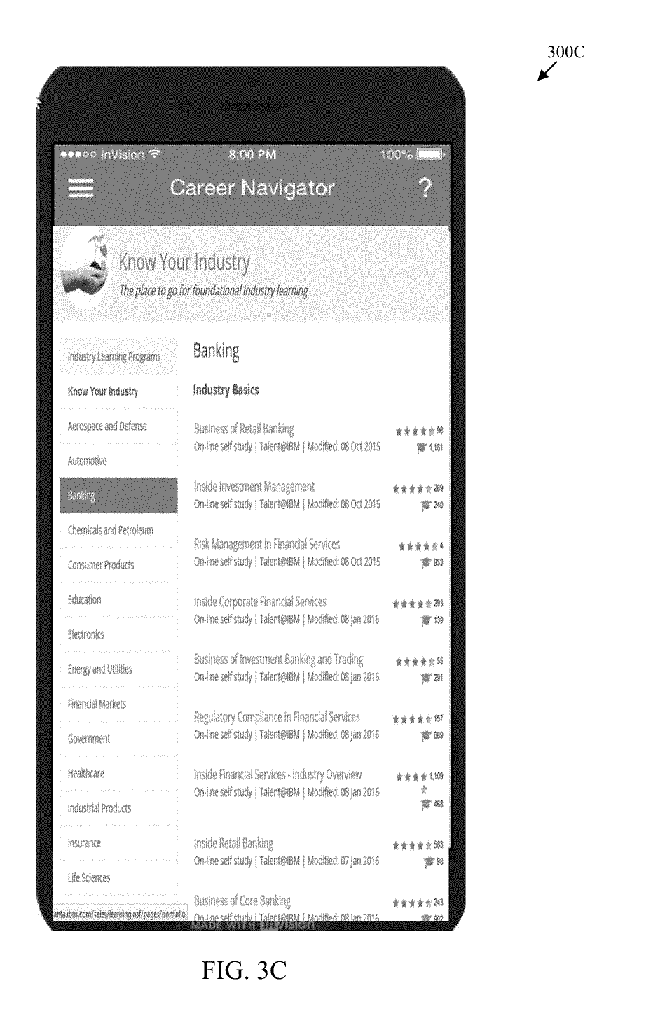

FIGS. 3A, 3B, and 3C are screen shots depicting several views of a user interface in accordance with at least one embodiment of the present invention. FIG. 3A depicts a first screen shot 300A of the user interface that enables a user to select various career navigation preferences with corresponding career navigation controls. Examples of career navigation controls include skill breadth, skill depth, compensation level, and required experience level. In addition to career navigation controls, the user may be provided with various interface options for viewing aspects of their personal profile such as skills, training (depicted as “learnings”), and assignments.

FIG. 3B depicts a second screen shot 300B of the user interface. In addition to the career navigation controls, the second screen shot 300B shows interface controls that enable a user to view recommended skills and professional development activities (depicted as “leanings”). FIG. 3C depicts a third screen shot 300C of the user interface. The third screen shot 300C shows interface elements that enable a user to learn about industry specific professional development activities including specific offerings for professional development activities.

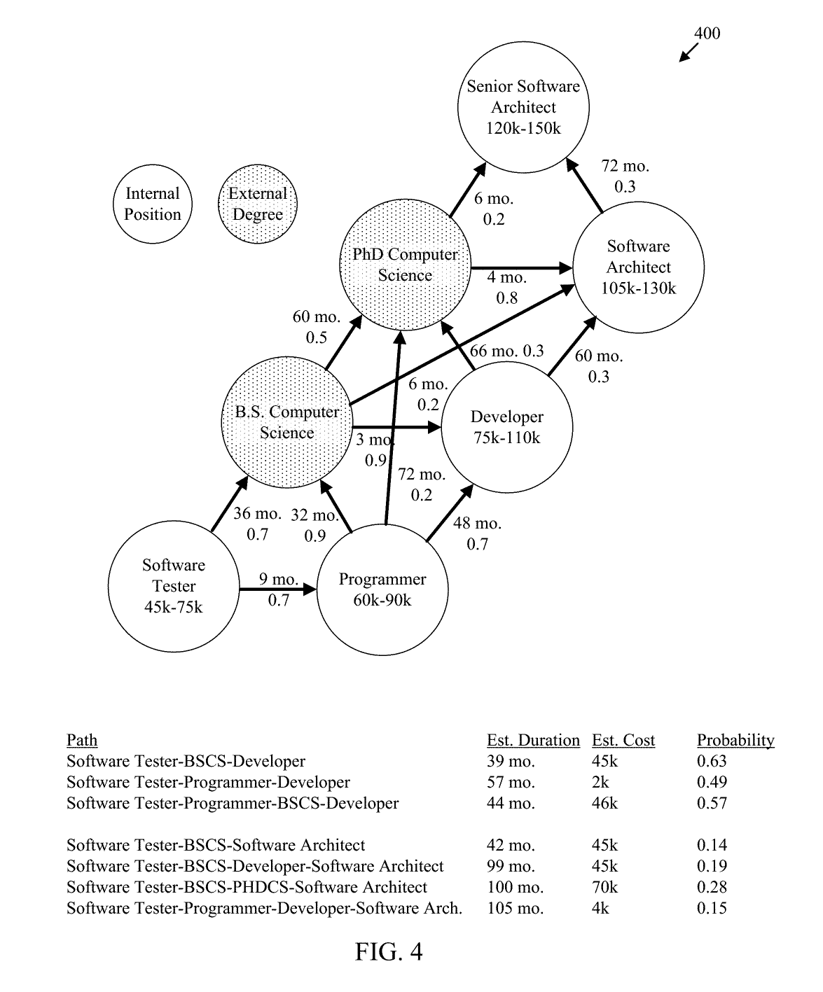

FIG. 4 is a dependency graph depicting one example of a career navigation map in accordance with at least one embodiment of the present invention. The career navigation map 400 displays various options (paths) for career enhancement along with various metrics associated with those paths such as suggested skills, intermediate positions, duration, cost, and probability. The career navigation map 400, and the like, are used to communicate various tradeoffs involved with attaining one or more target positions.

In the depicted example, the user is shown various target positions related to the current position of “software tester” including “programmer,” “developer,” “software architect” and “senior software architect”. In response to selecting a particular target position on the map the user may be shown the various paths to that position along with the estimated duration, cost, and probability of completion. In the depicted example, the estimated duration and cost are computed by summing the duration and cost of the segments included in the particular path while the probability of completion is estimated by multiplying the probability of completion of each of the segments included in the particular path.

For the depicted scenario, user selection of “developer” as a target position results in displaying metrics for three possible pathways with an estimated completion duration ranging from 39 months to 57 months, a completion probability ranging from 49 percent to 63 percent and estimated cost ranging from 2K to 46K. In contrast, selection of “software architect” results in four possible pathways with the estimated completion duration ranging from 42 months to 105 months, the estimated cost ranging from 4K to 70K, and the estimated probability of completion ranging from 14 percent to 28 percent.

One of skill in the art will appreciate that the present invention provides automated and personalized one-on-one career coach for employees of an enterprise that is available 24/7. Machine learning and cognitive technology are used to enable employees to understand what career growth opportunities or skill development activities will advance their career in context of what opportunities are, and will be, available within the corporation. Consequently, employers can more readily fulfill opportunities and maximize the return on their investment in their employees. Furthermore, the employee experience improved and voluntary attrition is minimized.

The described career navigational system is akin to a GPS (Global Positioning Satellite) system used in a vehicle or on a smartphone—that guides a user to their desired career destination with clear directions on what they need to accomplish and how long it will take them to get there.

In some embodiments, employees of corporations can set the values of specific career navigational controls (that may be defined by the enterprise) and receive back a set of skill development activities or career growth opportunities that are optimized for the employee based on the strategic objectives and imperatives of the enterprise and aligned with the career information available within the enterprise.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

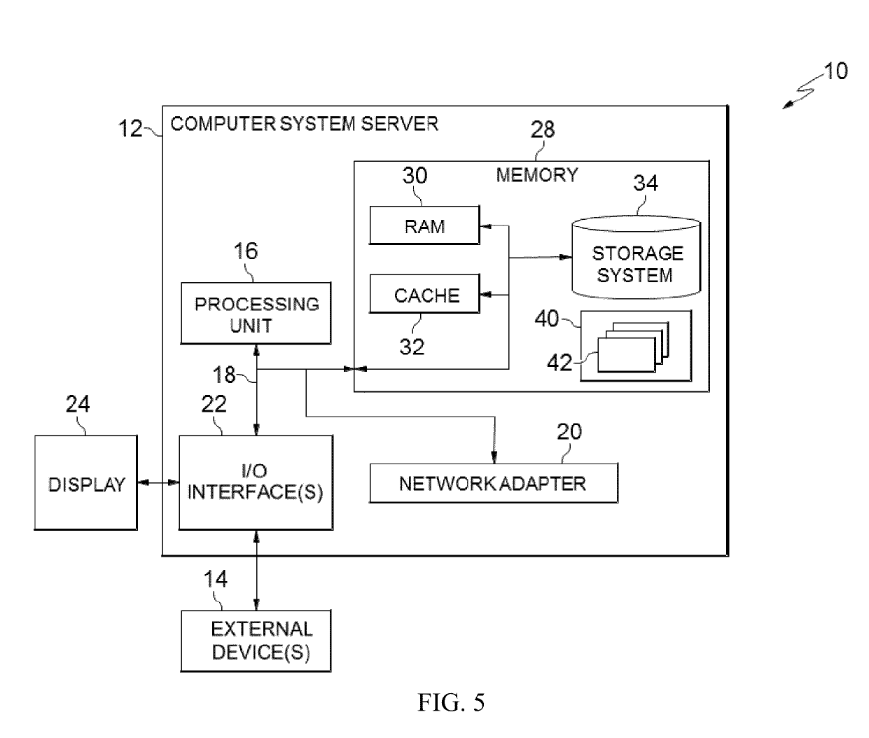

Referring now to FIG. 5, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 5, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

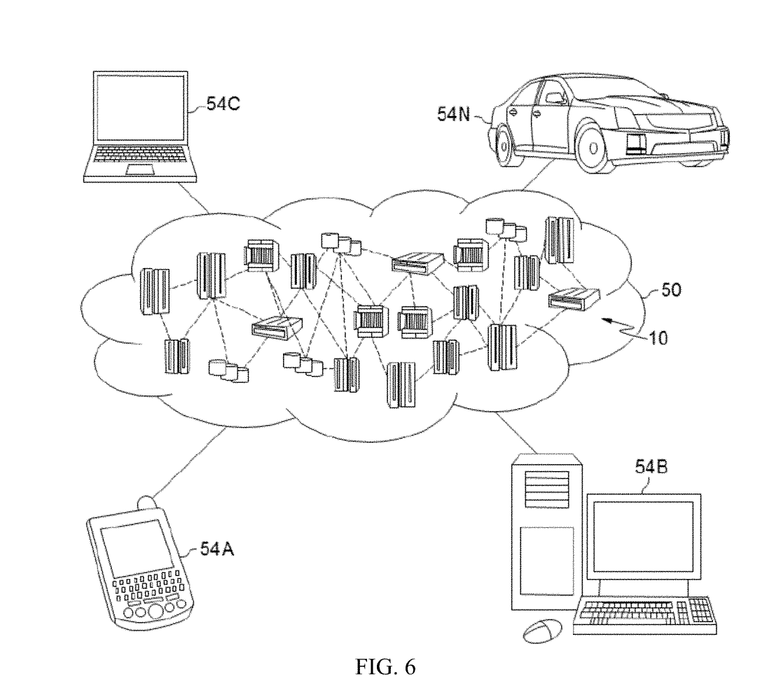

Referring now to FIG. 6, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 6 are intended to be illustrative only and that computing nodes 10 and cloud computing environment 50 can communicate with any type of computerized device over any type of network and/or network addressable connection (e.g., using a web browser).

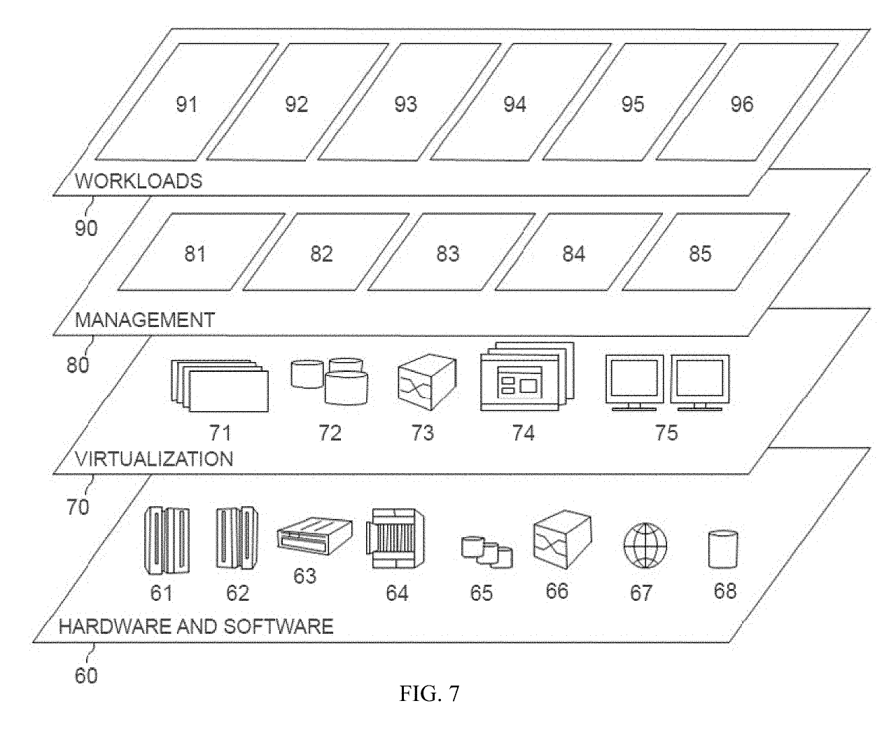

Referring now to FIG. 7, a set of functional abstraction layers provided by cloud computing environment 50 (FIG. 6) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and deployed enterprise application 96.

It should be noted that this description is not intended to limit the invention. On the contrary, the embodiments presented are intended to cover some of the alternatives, modifications, and equivalents, which are included in the spirit and scope of the invention as defined by the appended claims. Further, in the detailed description of the disclosed embodiments, numerous specific details are set forth in order to provide a comprehensive understanding of the claimed invention. However, one skilled in the art would understand that various embodiments may be practiced without such specific details.

Although the features and elements of the embodiments disclosed herein are described in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

1. A method, executed by one or more processors, the method comprising:
determining, via machine learning, skills associated with various positions in an organization wherein data for determining skills associated with various positions in the organization is provided by the organization;
receiving a profile for a user including a current position for the user;
presenting one or more target positions based on organizational priorities and a plurality of career navigation controls operated by a user, with the plurality of career navigation controls including a skill breadth career navigation control, a skill depth career navigation control, a compensation level career navigation control, and a required experience level career navigation control, and with the organizational priority being based upon a future demand of the target position determined automatically via machine learning of a positional skill analytics module;
receiving a target position for the user;
determining from the profile for the user and the skills associated with various positions in an organization, an acquirable skills data set including information indicative of: (i) a set of acquirable skills that would enable the user to achieve the target position from the current position, and (ii) a set of probabilities associated with the set of acquirable skills that indicate a likelihood that the set of acquirable skills can be acquired;
determining one or more professional development activities that correspond to the acquirable skills; and
presenting the acquirable skills and the professional development activities to the user, and with the presentation of the acquirable skills and the professional development activities including displaying a map from the current position to the target position.
